(19) United States
(12) Patent Application Publication
(10) Pub. No.: US 2006/0173729 A1
(43) Pub. Date: Aug. 3, 2006

(54) System and methods for managing a volunteer organization

(76) Inventor: Caleb Clark, Suwanee, GA (US)

Correspondence Address: MCKENNA LONG & ALDRIDGE LLP, 1900 K STREET, NW, WASHINGTON, DC, 20006, US

(21) Appl. No.: 11/045,474

(22) Filed: Jan. 31, 2005

(51) Int. Cl. G06F 17/30

(52) U.S. Cl. 705/10; 705/12

(57) ABSTRACT

A system and method for managing a volunteer organization such as a political campaign has a merit based recognition system, a centralized contact and task database. The system awards recognition or impact points to volunteers based on their participation in or completion of tasks, and also awards point to sponsors of those volunteers, thereby encouraging existing volunteers to recruit new volunteers and motivating volunteers to participate actively in the organization. The system also allows the campaign to generate automatically personalized e-mails and letters based on contact information and data from a specific activity, such as a recent telephone call or neighborhood canvassing effort.

### BACKGROUND OF THE INVENTION

1. Field of the Invention

The present invention is directed to software, computer systems and methods relating to management of personnel work flow and participation in a volunteer organization.

2. Discussion of the Related Art

Human resources and management information systems are well known in corporations and structured institutions for managing personnel, tasks, and work flow. It is well known in the art how such systems are able to organize and structure such information for a formal corporation or organization because inherent in these organization is the employee/employer relationship between the organization or institution and the worker. That is to say, it is understood that employees in formally structured organizations and institutions are being compensated monetarily for their productivity and for their work, therefore a management information system for such an organization is able to reliably make an assumption that tasks assigned to workers will be completed because the workers are motivated through financial incentive to perform the work assigned to them. Thus, such systems do not incorporate motivational or productivity recognition features in their designs

In volunteer organizations such as political campaigns, charitable organizations, or religious groups, for example, there is no employer/employee relationship. In these organizations, the volunteers charged with performing work are not being compensated for their work. However, because there is no employer/employee relationship, and the volunteers are not being monetarily compensated, it is very difficult in these organizations, loosely structured as they are to retain volunteers, to keep current volunteers motivated throughout the course of a project, and to have volunteers enthusiastically undertake tasks that may be considered menial, low-profile or uninteresting. This difficulty in motivating volunteers has made the information systems useful in corporate structures ineffective when used in a volunteer organization.

For example, in a volunteer organization, volunteers may join, leave, or participate to whatever extent they choose regardless of the particular needs of the organization. This makes the organization very difficult to manage and less likely to accomplish its objective. As a particular example, political campaigns rely very heavily on uncompensated volunteers to perform voter outreach programs, get-out-the-vote efforts, and distribute yard signs and bumper stickers. In a political campaign, the volunteers may be motivated by their support for the candidate, however, this enthusiasm may wane over time and their participation in the political campaign may drop off. Thus, it is necessary for the political campaign to find some way to attract volunteers, retain them, keep them motivated and enthusiastic throughout the course of the campaign and then, if possible, to use existing volunteers to attract and recruit additional volunteers. In addition, it's necessary that volunteers within an organization such as a political campaign not compete in a hostile, cutthroat, or aggressive manner with respect to one another because doing so can ultimately impede the success of the campaign. In addition, a typical political campaign with a small paid staff and a large base of unpaid volunteers, there is at present not way to make efficient use of the staff's time while mobilizing and efficiently using the volunteers.

What is needed is a mechanism for the staff to identify those tasks that need to be completed and delegate those tasks to volunteers willing to complete them quickly and efficiently.

### SUMMARY OF THE INVENTION

Accordingly, the present invention is directed to systems and methods for managing a volunteer organization that substantially obviates one or more of the problems due to limitations and disadvantages of the related art.

An advantage of the present invention is to provide a merit based recognition system to recognize the efforts and contributions of volunteers in the organization.

Another advantage of the present invention is to provide a system to automate the work flow and task pipeline of activities assigned to volunteers.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for managing a political campaign comprising a database server, a database, data of contacts, said data of contacts including at least one of contact information and demographic information of at least one contact, data identifying each contact in the database as a voter, supporter, volunteer, or staff member, data identifying a plurality of activities associated with the campaign, data of specific grassroots activities requiring volunteer participation, data of volunteers assigned to participate in at least one of said activities, data about a designated number of merit based recognition points awarded for each of said activities.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A illustrates a flow diagram according to an aspect of an exemplary embodiment of the present invention.

FIG. 1B illustrates a flow diagram of a canvassing effort according to a further aspect of an embodiment of the present invention.

FIG. 2 illustrates a flow diagram describing the analysis of relationships between contacts according to the present invention.

FIG. 3 illustrates a block diagram of the applications and modules of an embodiment of the present invention.

FIG. 4 illustrates a block diagram of voter, volunteer, and supporter interaction with the system of the present invention.

FIG. 5 illustrates a the sponsorship hierarchy according to an embodiment of the present invention.

FIG. 6 illustrates a hierarchy of links relating volunteers according to an embodiment of the present invention.

### DETAILED DESCRIPTION OF THE ILLUSTRATED EMBODIMENTS

Reference will now be made in detail to an embodiment of the present invention, example of which is illustrated in the accompanying drawings.

The system of the present invention enables volunteer organizations to make effective and efficient use of staff time as well as the volunteers' time. Central to the functioning of the system is the notion of volunteer and supporter impact points which are awarded to each volunteer based on their completion of a specific task or an activity. For example, on a political campaign there may be tasks such as placing a yard sign in a voter's yard, handing out bumper stickers, doing a neighborhood canvassing, making get-out-the-vote telephone calls, collecting new contacts and potential voters and the like. Each one of these grassroots activities may be assigned a predetermined number of impact points so that when a volunteer places a yard sign that volunteer is rewarded with that fixed number of impact points.

The system is intended to be all encompassing, integrating all of the data associated with the volunteer organization. For example, in the case of a political campaign, the database of the system will include not only the voter registration database available from each state but also any other publicly available databases such as credit reporting databases, direct mail databases, in addition to databases that may have been compiled by this particular political campaign in the past, such as a database a source of financial contributors, constituents from non-election years, the staff's own e-mail address, personal campaign contact, supports, friends and families, web site sign-ups and the like. In addition, the centralized database of the system of the present invention allows the staff and the candidate to perform event and campaign scheduling in the system. The political campaign has access to the entire universe of people potentially associated with the campaign at a variety of levels, including, financial contributors, supporters, volunteers and voters. Because the available information is centralized, either by collecting these databases and reporting them into a central database or simply accessing each of these individual databases either through networked data access program, the actual input of data into this system is able to be distributed, or decentralized.

With a centralized database operating on a server, for example as an internet application service provider, data may beentered into the system in any number of ways. For example, a voter may fill out a web site contact form on the campaign's web site and the data would then be automatically sent to the correct staff member for validation or approval or may be directly entered into the system without any further intervention. Another mechanism for entering data into the system may be that a volunteer would type in a voter's information from a sign up sheet at their home, using an ordinary web browser and internet access. Furthermore, a voter could request the yard sign through an electronic mail newsletter or on a form on the campaign's web site. A supporter could then pass on that same e-mail newsletter to their friends. In addition, the staff may add their own contacts directly into the system. All these pieces of information are stored in the centralized database and are available to the staff and to the rest of the system.

The system of the present invention incorporates all the data generated during a political campaign, identifies and organizes that data and then assigns tasks or takes immediate action depending on that information. For example, one of the problems in volunteer organizations in general is maintaining up-to-date contact records. Keeping contact information accurate and relevant may be very time consuming. But the database is only as useful as the accuracy of the information stored in it. However, if the staff is required to spend a great deal of their time correcting this data then the system ceases to enable the staff to function effectively and efficiently.

In the system of the present invention, when a staff member knows that a contact's or a group of contacts' information needs to be updated, the system allows them, through a button in a user interface or a simple command, to send a personal “direct update” e-mail out to the contacts with a request to update their contact information. Embedded in the direct update e-mail is the ability for the contact, who may be a supporter, a voter, a volunteer, or a financial contributor to update their contact information directly in that e-mail. In other words, the e-mail may contain data entry boxes for their address, telephone number, name, zip code, city, state and the like. The contact enters the information, presses the update button and the information is updated in the central database. The staff is not required to follow-up with time-consuming telephone calls to the contact, nor do they have to enter the data themselves. All that is required of the staff is to identify which piece of information needs updating, instruct the system to request that the information be updated by the contact himself. The contact simply corrects their own information, the system collects that information and in some embodiments impact points are awarded as well. If the contact whose information is being updated is designated in the system as a ‘supporter’, then they are awarded impact points for keeping their information up to date. This identifies the contacts the supporters to update their information to ensure that it is accurate and to ensure that it's done quickly and on time.

Furthermore, because the system of the present invention allows for distributed data input into a centralized database or network of databases, not only are contacts centralized but so are any tasks or activities the campaign needs to execute or organize. For example, throughout the course of a political campaign, voters may request yard signs, bumper stickers and other promotional material. In addition, the campaign itself may organize door-to-door canvassing efforts and phone banks. The campaign also distributes e-mail newsletters, educating supporters and voters on related news about the candidate and the campaign. They may also track new voter registration. The system of the present invention allows this information to be stored and the progress of each of these tasks monitored.

As noted earlier, a key feature of the present invention, is merit based volunteer recognition. In an embodiment of the present invention, this may take the form of awarding impact points to volunteers for completing or participating in different activities. In addition, the impact points may be awarded when a volunteer brings in additional volunteer, that volunteer is awarded some portion of the impact points collected by those volunteers that he brought in. In other words, a volunteer may receive impact points based on the grassroots actions that he performs for the campaign and he receives impact points based on a portion of the impact points of the volunteers that the original volunteer had recruited. The mechanism for assigning the impact points will be discussed in detail below.

Because the data of the campaign is centralized, including the contact information of all the volunteers, it becomes much more efficient and easier to mobilize these volunteers to undertake certain tasks. For example, if a volunteer calls a campaign inquiring about what work they can do for the campaign that day, the person who takes the call at campaign headquarters can simply check the list of open tasks in the system that need to be completed (handing out yard signs, bumper stickers, participating in get-out-the-vote phone banks or doing neighborhood canvassing). The person taking that call can simply click a button on the screen that immediately sends that task or activity by e-mail to the volunteer along with all the information needed for that volunteer to complete the task. For example, in the case of a yard sign that e-mail would contain the address of the voter and the location where the sign may be picked up. When the volunteer completes the action the volunteer may note this by logging into the system from home or they can contact campaign and let them know that they have completed the action. Once they update the system with information that the activity has been completed, the activity is removed from the list of open tasks and that volunteer is awarded the impact points.

For example, in the past when a voter called campaign headquarters requesting a campaign sign, the staff would have to look at a map, identify where that voter lived, then identify the coordinator of volunteers local to that voter, contact them and assign a volunteer to handle it. This is extremely time-consuming for the staff. In the system of the present invention the entire process is managed automatically. Once the voter requests the sign either through the web site or by telephone, the system may allow a number of sign requests to accrue and then can batch delegate the open sign placement tasks to volunteers. The system is able to identify each volunteer who lives near voters who have requested sign by comparing their contact information with that of the voter through a post office database or other geographic information system. Then the system may batch delegate the accrued tasks, e-mailing the volunteer for each one of the open sign requests. The volunteer places the sign, updates the system informing it that the sign has been placed and the task completed and the impact points are then awarded.

Thus the system of the present invention manages tasks in a pipeline. The first stage of the pipeline are incoming tasks. This is where, for example, the voter has requested a sign. Once a predetermined number of requests, or incoming tasks, have accumulated, the system organizes the incoming tasks into groupings that are delegated to specific volunteers so that if a number of sign requests come in for the same geographic area all the sign requests may be delegated to the same volunteer. Once those tasks are grouped and delegated to a volunteer they become ‘pending tasks’ which remain pending until the volunteer accepts the task. Once the volunteer accepts the task it becomes a delegated task and the system interprets this to mean that the volunteer has now picked up the yard sign. The staff can view the number of yard signs completed because when a yard sign is placed (and the volunteer informs the system of that placement) the delegated task becomes identified as a completed task. The staff can view these results in real time, and all of the tasks may be archived for reference.

Because the database of the system of the present invention contains information about voters from a variety of sources, the system of the present invention enables the customization of each particular voter outreach effort in order to specifically target a certain category of voter in an efficient manner. Specifically, because the database contains centralized information about voters, the system may provide a voter outreach wizard to set up the outreach effort. The wizard may take the form of a multi-step or multi-page computer user interface that prompts the user of the system with user-friendly questions in order to categorize the voters that are stored in the system. For example, the questions may be “Do you want Republican voters, Democrat voters, or swing voters?”. Other selection criteria may be based on sex, ethnicity, age group, income level, or any other type of information that is stored in the centralized database and may beused to characterize or classify voters. Once the user has entered in that information, the system prints pre-formatted sheets for the volunteer to take with them as they canvas the neighborhood. These sheets contain questions tailored for those specific voters requested using the wizard. In addition, these sheets include bar codes (the functioning of the bar codes will be discussed in detail further below). So the volunteers that canvas the neighborhood are not required to write down any information. Rather, they highlight the bar code appropriate to the answer to that voter. Once the neighborhood canvassing is completed the sheets are brought back to headquarters or the volunteers take them home and use an inexpensive hand held bar code scanner to scan the sheets. In addition those sheets include bar codes relating to typical voter requests such as yard signs or bumper stickers so that once a voter's request for a yard sign is scanned with a bar code reader it enters the task pipeline discussed earlier for assignment to a volunteer. In addition, the merit based recognition system mentioned may award volunteers impact points based on their participation in this particular neighborhood canvassing effort.

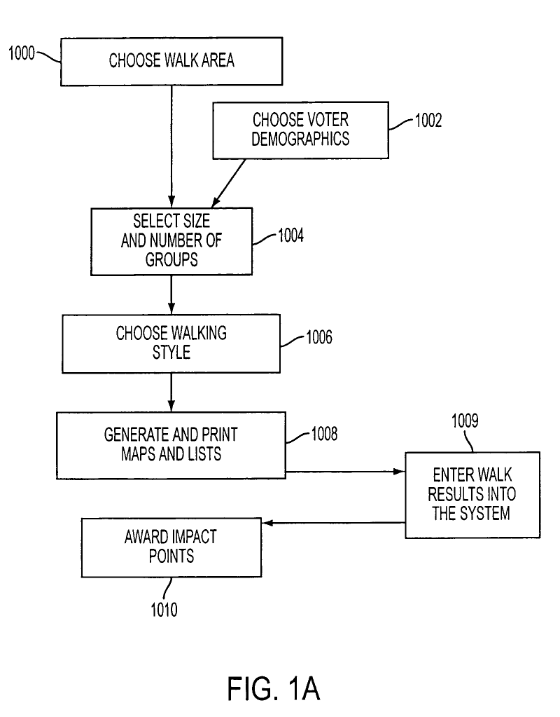

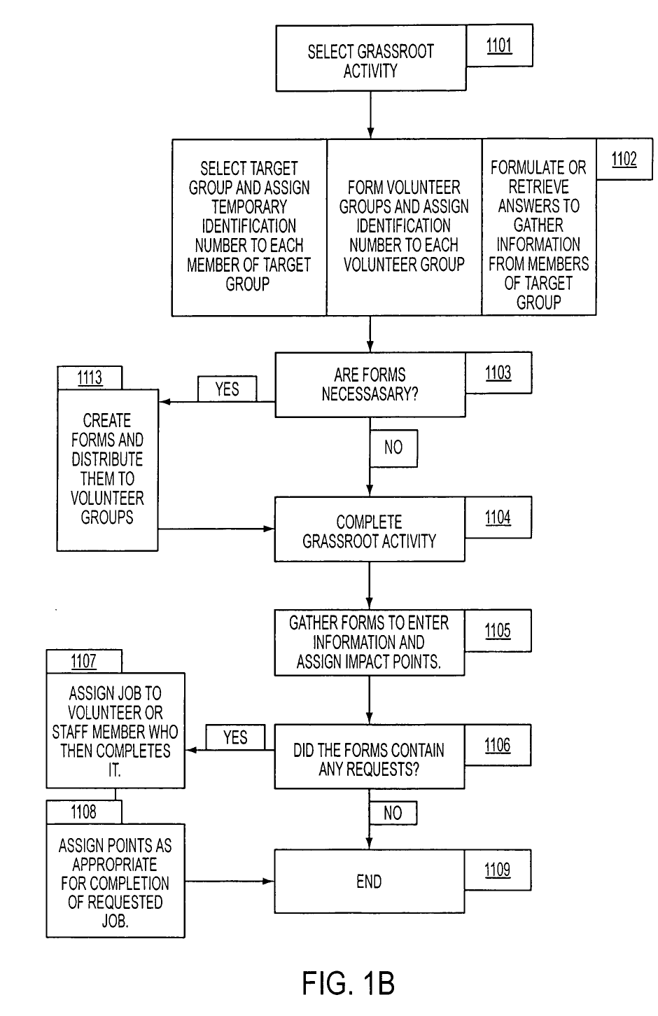

The voter canvassing wizard of the present invention will now be described in detail with reference to FIG. 1A. FIG. 1A illustrate a first exemplary embodiment of the voter canvassing wizard of the system of the present invention. Initially, at step 1000, the wizard prompts the user to choose the area to be walked by the volunteers. This choice may be made based on geographic area or, according to step 1002, based on voters' demographic information such as their party affiliation, ethnicity, income level, marital status, gender, etc. At step 1004 the wizard prompts the user to select the size or number of volunteer groups who will be participating in this voter canvassing effort. In particular, at step 1004, the user will know in advance how many volunteers are available for this particular canvassing effort and will thus divide volunteers into the appropriate number of groups to efficiently and expeditiously conduct the canvassing effort. In an alternative embodiment, the system may identify which volunteers are available and divide them up randomly. The system will then take the volunteers in each group and use this information to assign the voters to each group. In step 1006 is an aspect of the embodiment of the present invention the system will promptly the user to choose a walking style. The walking style could be a zig zag across the street, down one side of the street and back up the other side of the street, or some other understood walking style of the art. This will place the voters that have been selected into the proper order for each group. The system then generates and prints maps of the walking area 1008, draws lists for each voter. As was discussed earlier, the questions and answers have already been selected so that each voter sheet will include the voter's name, the question that is being asked for or simply a series of answers, each with a bar code corresponding to each answer as well as some voter outreach features such as a request for yard sign or bumper sticker or the like. The system of the present invention assigns those bar codes based on the group number, a temporary voter I.D. number and the answer I.D. Another aspect of this embodiment will also put a bar code at the top of the sheet identifying this particular canvassing effort. Because the list for each voter is printed using bar codes all that is required of the volunteers is that they simply highlight, with a colored marker, for example, which answer the voter has selected after the visit to the door and then return those sheets to the campaign headquarters. The campaign can then collect all the sheets using a simple bar code scanner to very quickly and very accurately enter all the answers corresponding to each voter who is in the system at 1009. This significantly reduces data entry time. It maximizes the efficiency of the staff and also provides for data that is much more precisely tailored to each voter or each supporter. A further aspect of this embodiment impact points are awarded the entire group 1010, to each volunteer in a group based on the number of voters that group was able to contact. In a further aspect of this embodiment, the number of impact points awarded to that group would be increased further based on a voter's request for campaign information materials, or that voter's indication of willingness to offer further support to the campaign, such as, for example, requests for yard signs or bumper stickers. This allows the campaign to track which volunteers are able to energize, motivate voters to request yard signs and to discuss a preference for a candidate in question because it knows which volunteers are in which group.

This wizard illustrated in FIG. 1A could be used not only for neighborhood canvassing efforts but for get-out-the-vote effort, phone banks and the like. It may be used for any grassroots activity where volunteers must target voters on a precise and accurate basis without overwhelming staff with time consuming tedious data entry.

In a further aspect of this invention, illustrated in FIG. 11B the system of the present invention provides a method to assign volunteer groups a specific grassroot activity for a target group. Additionally, this process allows for an efficient and fast methodology to create forms used to collect and record the information the volunteers obtain from the target group members.

First step 1101 is to select what grassroot activity to complete and when to complete it. A grassroot activity may involve a job such as a walk, a phone poll, posting or delivering signs and the like. Each grassroot activity is assigned a specific name by which it may be referred. The name may be descriptive of the job that it involves and may include information as to when the activity was performed, for example a date. Each grassroot activity is also assigned a unique number identifier and stored in the system. Once an organization has selected the grassroot activity it must determine which volunteers will participate and who is to be targeted.

A target group may be any predetermined group of individuals that share one or more attributes. Target groups may include, but are not limited to, registered voters, residents of a specific locality, a specific gender, people affiliated with a specific political party, people of a specific ethical background or any combination thereof. Therefore, the size of a target group may be large or small. For example some target groups may be very narrow and small in size, for example it may be made to include all registered republican married women voters who have children and who reside in a specific zip code. On the other hand some target groups may be very broad and larger in size, for example a target group may be all people who have two vehicles and live in single family homes. The number of ways to define a target group is only limited by the extent of available information about a population. For example, if a target group were formed out of the population of all registered voters, the information available would include all accessible data for each individual registered voter. Once a target group is defined, each member of the target group is assigned a temporary identification number.

If the activity is done to collect information then questions also need to be drafted. The present invention involves either the use of multiple choice questions or just a list of answers, which here is broadly meant to include any facts or characteristics and not necessarily answers to questions. For example, the answers may be a list of issues, from which a target group member identifies all of those that are important to him. Independent on the format, each answer is assigned a two digit code identifier and stored in the system. The questions and answers may be on any issue. Furthermore, the answers may involve a request. For example it may indicate whether someone would like a sign, more information, subscribe to a newsletter or the like. Thus, depending on the answers a form may also work as an order form or as a registration form.

In addition to selecting the target group and the kind of information sought from the target group, the system involves the selection and organization of volunteers. Volunteers are contacted and those who decide to participate are divided into volunteer groups. Each volunteer group may be randomly assigned a group identity number. Each volunteer group may comprise a group leader, who may or may not be identified as such in the database or through the application's business logic. The number of volunteers in each volunteer group may be adjusted based on the nature of the activity and the number of volunteers available. Additionally, while an aspect of the present invention deals with volunteer organization it is not intended to be limited for such a purpose. This process may be just as effectively applied to non-volunteer organizations.

Once the target group has been defined, the answers determined if needed, and the volunteer groups formed, the assignments 1102 are made. In making the assignments 1102 each volunteer group is matched with a subset of the target group and, if needed, equipped with forms as shown in steps 1103 and 1113.

If information is to be collected forms are used. Each form may be specifically tailored to each member of the target group. Each form may contain at least the information specific to a member of the target group. In one aspect of the present invention a form may list the name of a target group member and any additional information about that member such as address, telephone number and the like. All the forms may contain a common barcode that identifies the unique grassroot activity number for which they were used. Furthermore, each form may contain a list of answers that the volunteer will ask the target group member. Each form may contain answers specifically tailored for the respective target group member. Alternatively, all the forms may contain the same answers. The forms may also contain any additional information as may be deemed appropriate.

Corresponding to each answer on the forms is an answer barcode that identifies that answer. These answer barcodes may also associate each answer to the target group member identified on the form. Furthermore, the answer barcodes may comprise the identification number of the volunteer group of the volunteer who used the form when contacting the target group member. The answer barcodes may, for example, comprise nine digits. The digit size of an answer barcode is only limited to the space available on the form and the barcode format being used. Because the identification numbers of the target group members are only temporary they may be reused for different grassroot activities. This prevents having to continuously expand the size of answer barcodes and thus it allows for maintaining the desired digit size. Furthermore, it allows the system to be used with simple barcodes formats well known in the art (such as, but not limited to, Code 39 Normal and Full ASCII, UPC, RSS-14, Codabar, Descrete 2 of 5, Interleaved 2 of 5, Code 1128, EAN/UCC 1128, Postnet, Postal FIM Patterns, PDF417, Data Matrix, Maxicode, Aztec code, MSI/Plessey etc . . . ) that may beprinted with ordinary ink jet or laser printers and read using low-cost, handheld barcode readers. In a further aspect of the present invention the answer barcodes comprises nine digits. The first five digits of the answer barcodes correspond to the temporary unique identification number assigned to the target group member identified on that form. The remaining digits of the answer barcodes may comprise the volunteer group identification number and the answer identification number of the answer associated with that answer barcode. The answer barcodes may also comprise additional identification numbers such as for example the grassroot activity number thereby allowing for the omission of having to print the grassroot activity number barcode separately on the forms.

After the volunteer groups are matched with, and thus have a list of, the members belonging to the target group, and the respective forms, if any, are distributed, the volunteer groups complete the grassroot activity as shown in step 1104. When using the forms, the volunteers will mark the chosen answers on each form. In step 1105, i.e. once the activity has been completed, the forms are returned to the volunteer organization and the information may be entered in the system and impact points are awarded.

This system provides for an efficient and expeditious way to enter the information and award impact points. Data entry of the information into the system requires the simple act of scanning the barcodes of the chosen answers. Having the volunteer group identification number, the temporary target group member identification number and the answer identification number allows the system to read the information and associate it with the data already in the system. Having the volunteer group number allows the system to recognize which volunteer group and thus which volunteers obtained the information on this form and thus can assign impact points respectively. The temporary identification number of the target group member allows the system to associate the information from the answer with the specific member. Finally, the answer identification number allows the system to associate the answer written on the form with the member by pulling the information from the system thus preventing any mistakes that may be made by having the one scanning enter that information each time.

Choosing the identification number of each volunteer group at random results in less repetitious numbering of volunteer groups between different grassroot activities thereby providing for a way to confirm that the data being entered is for the correct grassroot activity. This problem may arise when one scans barcodes from forms that relate to different grassroot activities. Assigning random identification numbers to the volunteer groups for each grassroot activity increases the variety of identification numbers used for the volunteer groups of different grassroot activities independent of the number of volunteer groups involved in each grassroot activity. The system may then be able to automatically confirm whether the information being entered is associated with a volunteer group that was involved in that specific grassroot activity. If the volunteer group identification number does not match with one of the identification numbers of the volunteer groups that took part in that grassroot activity, the system may alert who is entering the information informing them of the mismatch.

For example, if two grassroot activities each involve three volunteer groups and the three volunteer groups were sequentially numbered each time as groups one, two and three, then when the information is entered the system would not be able to check whether a piece of information from a barcode that identifies volunteer group number two is from the first grassroot activity or the second grassroot activity. On the other hand, if the volunteer groups were assigned random identification numbers for each grassroot activity such as for example the number one, ten and nine for the volunteer groups in the first grassroot activity and the numbers three, seven and twenty for the volunteer groups in the second grassroot activity the system would be able to confirm whether the information is being entered for the correct grassroot activity. For example, in such a case, if while entering the information for the first grassroot activity someone inadvertently were to scan the barcode of a form volunteer group with identification number three provided, the system would recognize that there was no volunteer group with identification number three involved in the first grassroot activity and would thereby be able to alert the person entering the information of the mismatch.

According to the present invention variations on how points are awarded may be made if after the assignments are made changes occur in the number or identity of the volunteers in the different volunteer groups. For example, a modification to the point award is made if after starting the grassroot activity an additional volunteer joins one of the volunteer groups, or if a volunteer leaves a volunteer group. In the case of such occurrences, only a percentage of the points are awarded to those who either joined late or left early. This percentage may depend on the amount of work done by the individual volunteer and/or the time the volunteer actually spent in taking part in the grassroot activity.

In addition to recording information and awarding points, the answer barcodes allow for the automatic reassignment of jobs if necessary. As stated above, the answers may also comprise requests or registration forms. A request may be for example someone asking for marketing materials such as a sign, bumper sticker, or for more specific information such as a donor packet, or the like. A registration form may involve newsletters, volunteering, donations or the like. As shown in step 1106, if such request or registration is present than the system can identify it and thanks to the answer barcode can associate it with the person who made the request. Thus, it becomes an efficient way to instruct a staff member or another volunteer to take the step necessary to comply with the request. For example, as shown in steps 1107 and 1108, if someone asked for a sign, a volunteer can easily be contacted and efficiently given the information of the individual who asked for a sign so that the volunteer can promptly deliver the sign and thus earn more points.

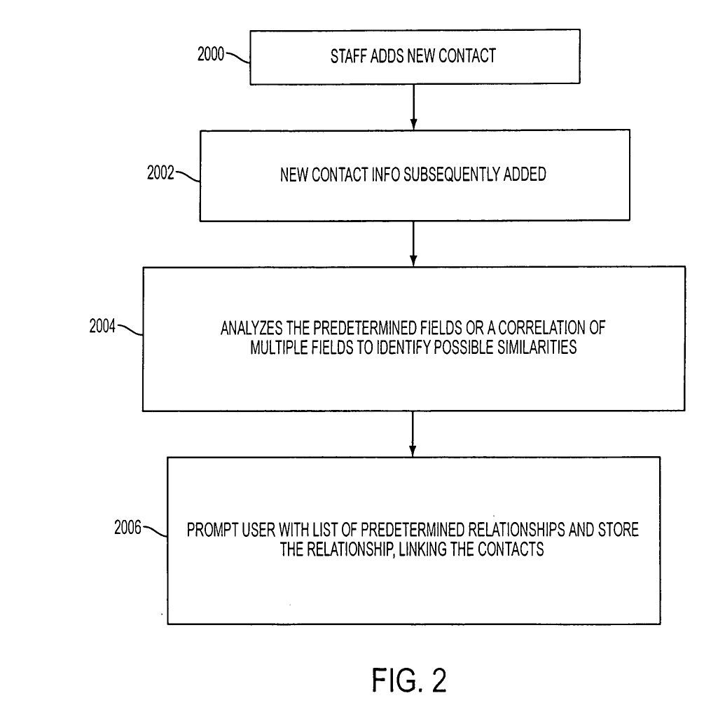

In order to efficiently conduct voter outreach efforts, it is necessary to intelligently organize contacts to reveal relationships between new and existing contacts. One of the key features of the present invention is also its ability to manage these contacts in an intelligent way. For example, in most circumstances where two contacts who reside at the same address, whether wife, brothers, siblings, roommates, or the like, it can create inefficient and embarrassing redundancies such as when a campaign contacts volunteers at the same house twice in the same night. This is frustrating not only for the staff but also for the volunteers as well. The system of the present invention includes a contact relationship analyzer that has the capability to as illustrated in FIG. 2 to note when a staff member has a new contact at step 2001. At step 2000 the system stores this contact information in the manner described above by storing it in a central database. Then when a subsequent staff member has another new contact or when a contact fills out a web form at step 2002 the relationship analyzer of the present invention checks the fields of contact information for any redundancies or similarities. This is of particular usefulness because it is common in volunteer organizations and political campaigns especially that all of the contact information for a particular contact is not available. For example, if a voter or supporter only received a newsletter, the campaign may only have that contact's name and e-mail address. However, in a neighborhood canvassing effort the volunteer (via the campaign and the centralized database) may obtain that voter's name, address and telephone number but they may not have that contact's e-mail address.

The system of the present invention at step 2004 compares the fields of the newly added contact to those of a previously existing contact for similarities. These similarities are based on predetermined fields such as last name, street address, apartment number, city, state, zip code, telephone number, cell phone number fax number and the like. In addition, the system has the ability to correlate multiple pieces of information. For example, if two contacts have the same last name that in and of itself may not indicate a relationship between those two contacts. However, if the contacts with the same last name also have the same street address or same zip code, this increases the likelihood that contacts are related, but the system at step 2004 based on the identification of possible similarities will prompt the user, that member volunteer, to inquire of the contact whether or not they share a relationship with this previous contact. For example, the system may prompt the user with a question during the data entry of the new contact information or immediately after the new contact information has been submitted to the database. The question asks the user to identify a relationship between the first contact and the one being added. The relationship is chosen for a list of predetermined relationships, such as “same person, husband, wife, family member, sibling, roommate or the like”.

Thus, if the new contact informs the user that she is the wife of a previous contact, for example, that relationship in particular is stored in the database linking the two contacts so that the campaign is able to maintain a more personal relationship with its contacts because is aware not only of that particular contacts involvement in the campaign, but also the involvement of other contacts related to that contact.

In addition, through centralization of contact information, the system of the present invention enables the use of a template letter writing and e-mail system which is able to generate correspondence with supporters and volunteers based on their contact information and information about an activity that the supporter or volunteer may have interacted with. This establishes a more personal relationship between the contact and the campaign without burdening the staff with the task of drafting letters for each of the contacts established during the campaign. For example, the e-mail or template-based letter generator can also be used in conjunction with the voter outreach effort with the neighborhood canvassing effort because the particular voter's specific answers to the questions stored in the database the template-based e-mail letter writing generator can take that information and create a letter personally thanking that voter for their support of the campaign by incorporating into that letter that voter's specific answers to questions asked during that neighborhood canvassing effort. This further strengthens the personal connection between the voter and the campaign in a manner that is efficient and does not burden staff with tedious data entry.

For example, some specific applications of the template-based e-mail or letter generator would be to send a welcome message when a staff member assigns a new leader to a volunteer team, or a thank-you note when a supporter requests a yard sign thanking that supporter for their interest in the campaign and their willingness to place a sign in their yard. The generator may also be used to send instructions to volunteers about precisely how to conduct a specific grassroots activity. It may also be used as a motivational tool by sending a congratulatory message to a volunteer who has reached an impact point milestone. It is understood that the applications of the template-based e-mail letter generator are limited only by the specificity of information in the database relating to each activity, voter, supporter, contact, or volunteer.

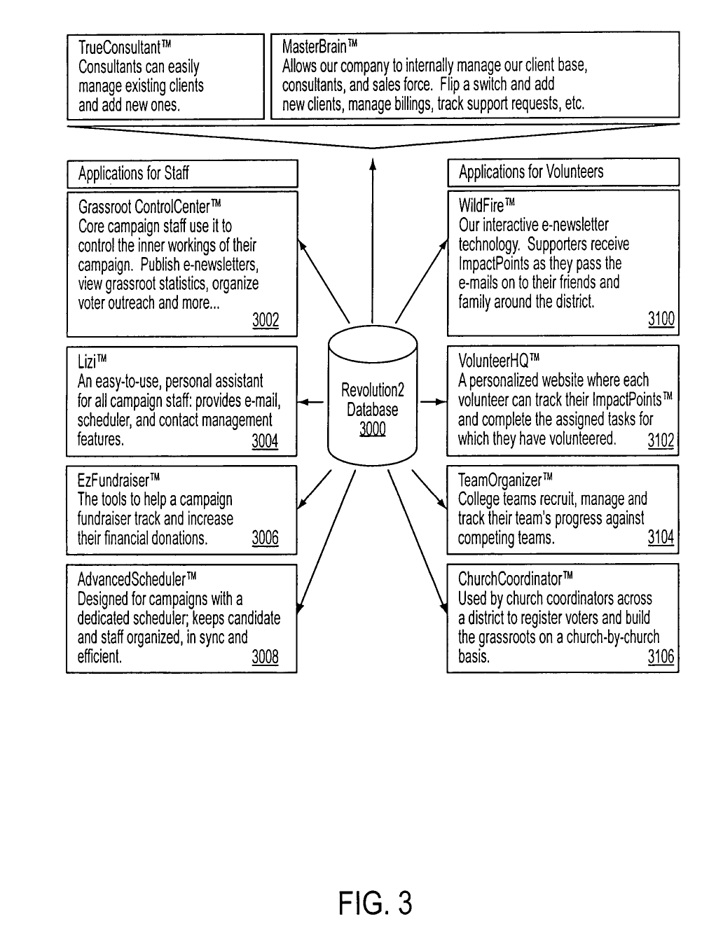

A particular example of an embodiment of the system present invention will now be described with reference to FIG. 3. In this exemplary embodiment, modules according to the embodiment of the present invention are now described in detail. In addition to the centralized database 3000 the modules are applications associated with the present invention are divided into applications for the staff and applications for the volunteers. Notably, all of the applications pull their data from the same source thereby ensuring that the data presented remains consistent across the entire system no matter who in the organization is reviewing the data.

Among the applications for the staff are a control application 3002 from which staff are able to control the inner workings of the campaign, such as publishing e-newsletters, viewing the grassroots activities statistics, viewing statistics about volunteers, organizing voter outreach efforts, or triggering the neighborhood canvassing wizards and phone bank wizards described earlier, for example.

Application 3004 functions as a personal information manager for each staff member providing information specific to the campaign and their role in it. Application 3004 provides access to their campaign e-mail, a scheduler, and a contact manager, all of which draw on the contact information stored in the central database 3000.

In addition, in further aspect of this embodiment of the present invention, a fundraiser tracking module may be provided (“3006”) which includes tools that allow the campaign to track those contacts that have donated money to the campaign, thereby allowing the campaign to more intelligently target donor and raise further contributions.

Finally, in other aspects of the invention, an advanced scheduling system separate from the personal information manager 3004 is provided at 3008 which allows the campaign to coordinate a unified scheduling system which keeps the candidate and the staff organized, synchronized, and efficient regarding each others whereabouts, workloads and schedules.

In addition to the applications for the staff, the system of the present invention provide applications for the volunteers. Included among these applications is the interactive newsletter technology 3100 which enables supporters to pass along a newsletter to their friends or family in the campaign region. The e-newsletter monitors to whom it is being forwarded and awards impact points to that supporter for each person they send the e-newsletter to.

In addition, the system may provide a personalized website or homepage 3102 for each volunteer where they can track their impact points, complete assigned tasks which they have volunteered, and view all open tasks which they have volunteered but have not yet completed. In the personalized homepage, they may also view their buddy lists of those volunteers on the campaign with whom they have a direct and immediate link.

Furthermore, in another aspect of the invention, a team organizer application 3104 is provided in which teams of volunteers are able to track their progress as a whole and compete in a friendly manner against other teams on the campaign.

Furthermore, a church or other affiliated volunteer organization coordinator application 3106 is provided which enables the coordinators for each church or other volunteer group to register voters from their church or volunteer organization thereby building the grassroots base of supporters, voters and volunteers on a church-by-church or volunteer group-by-volunteer group basis.

In addition, in those embodiments where the system of the present invention is deployed in a client server environment such as that found on the internet, it is understood that a number of political campaigns may be running each of their centralized databases off of a single server this allows the server to take advantage of further efficiencies, namely, that the owner of the server system may view and analyze all of the central data on the centralized databases for each of the volunteer organizations. This “master control” embodiment allows each of those campaigns connected to the central system that are running the system of the present invention to take advantage of resources that are provided and made available to all of the campaigns. These resources may be party officials, political consultants, financial accounting systems, technology consultants and the like. This way each campaign is able to draw from a common, trusted pool of resources from each of other campaigns. For example, if a number of state campaigns all belonging to the same party are each running the system of the present invention off of the same server or off a networked group of servers, the master control system enables the national party headquarters to view the progress of the volunteer efforts in each of those state campaigns. It is likely that each of those state campaigns may be willing to share some data, though not all of it, with the national party leadership or directly with other campaigns. In exchange for access to that data, the national party may make available nationally recognized political consultants or campaign managers to each of the campaigns. This may be done efficiently because the master control will know immediately which state campaigns are having difficulty, which ones are have successful or unsuccessful volunteer efforts and the like. Furthermore, this allows data to be mined across all of these campaigns, enabling the system to identify, for example, donors who have donated to a number of different political campaigns within the same party, or volunteers who are volunteering for a number of political campaigns that may be deserving of special recognition by the party leadership or by a national candidate.

The e-newsletter technology application 3100 in FIG. 3 will now be described in additional detail. In a further embodiment to the present invention, the e-mail newsletter done in related art political campaigns is replaced by an interactive viral marketing tool that duplicates and replicates itself through its distribution by supporters. By integrating this feature with the impact points feature, this helps to incentivize supporters into passing the newsletter on to their friends or family, allowing them to view immediately the tangible results of their support.

Specifically, a supporter having received the interactive e-mail newsletter may pass it on to three of their friends. For each one of their friends that opens that e-mail or interacts with it (for example by entering their contact information), the initial supporter is awarded impact points. In addition, the initial supporter is awarded impact points as each of those three subsequent supporters further passes the e-newsletter on. Furthermore, the original supporter is awarded a small amount of impact points for the distribution of the interactive e-mail newsletter by supporters one or more people removed from them. This supporter can see, over time, the number of impact points increasing as that initial e-mail newsletter that they forwarded to just three of their friends spreads out across dozens or hundred of other voters. This becomes an excellent means for informing the supporter of the impact of their efforts by sharing that e-mail with three of their friends. Furthermore, by integrating the e-mail newsletter with the e-mail letter template generator, the e-mail itself may be personalized so that it appears to have come originally from a friend. In addition, the interactive e-mail newsletter may include a button allowing any supporter who receives the e-mail to request a yard sign or participate in another grassroots activity. The participation in these activities by subsequent supporters or volunteers also results in awarding impact points to the initial supporter.

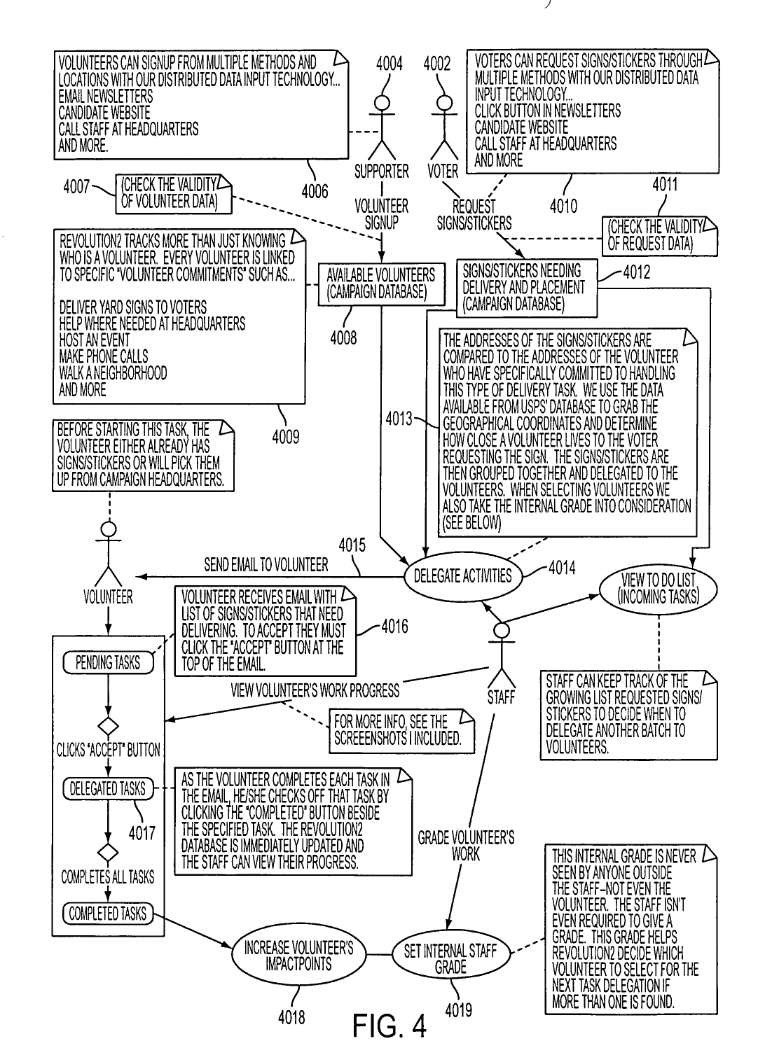

The technical operation of an embodiment of the present invention will now be described in detail with respect to FIG. 4. In this embodiment, the system distinguishes between supporters, voters and volunteers, although their information is stored centrally in the contact database. A voter 4002 is identified merely by their presence in the voter registration roles obtained from the state or from some other centralized and publicly available database. A supporter is a voter who has expressed interest in the campaign or the candidate. A supporter may be someone who has requested a signed or someone who has expressed a strong interest for the candidate based on their answers during a recent neighborhood canvassing effort. Supporters are identified as 4004 in FIG. 4.

Once a supporter 4004 has been identified, the system according to the environment of present invention, enables the centralized database to remember which volunteer initially contacted the supporter and can store that information. The mechanism for accomplishing this is a latent link between the supporter and the volunteer.

The supporter can sign up to be volunteer through an e-mail newsletter, a candidate web site, contact the staff directly at headquarters or any other well understood method at 4006. The system then verifies the validity of the volunteer contact information that was entered at 4006, and also verifies the relationship or checks the relationship linking discussed with respect to FIG. 2 to determine if this newly-added volunteer has some relationship with an existing volunteer. This supporter then becomes entered as a volunteer in the volunteers database 4008, at which point they are available to be linked to specific volunteer commitments or grassroots activities at 4009.

The voter 4002 interfaces with the system and the campaign by requesting signs or bumper stickers through the multiple methods discussed with respect to the distributed data input technology, such as for example, by clicking a “request yard sign” button in the newsletter, clicking the same kind of a button on the campaign's website, contacting the staff directly at headquarters by telephone or like 4010. This request is similarly verified by the system at 4011, and this voter's particular request is added into the database in the pipeline of signs and stickers that need delivery and placement 4012. The addresses of the voters who requested the signs and bumper stickers are compared to the addresses of the volunteers specifically committed to handling this kind of a delivery task. The system is able to interface with any available from the U.S. Postal Service database to grab geographical coordinates and determine how close the voter lives to any of the volunteers in that database. The requests for signs and stickers are then grouped together and delegated to the volunteers such that voters in the same area who have requested signs may be serviced by a volunteer at the same time requiring only one trip rather than two. This is step 4013. All of this information integrates into the system which delegates these activities at 4014, matching requests for signs, stickers or other grassroots activities to those volunteers who have indicated or expressed an interest in handling those requests. In a further aspect of this embodiment, the system then automatically sends an e-mail to the volunteer at 4105 and using the e-mail template generator provides that volunteer with specific instructions, a map or other information about executing this task. This information may be where the signs and bumper stickers may be obtained or other information. Once a volunteer receives the e-mail, the volunteer has either already picked up the signs and stickers or will pick them up from campaign headquarters now that they know they are responsible for delivering these signs because they have committed to the task. This volunteer may receive one or more e-mails with a list of all the stickers that need delivering. To accept responsibility for the task, they may affirmatively accept the task 4016. Once they have accepted the system moves this activity through the pipeline from the pending task list to the delegated task list 4017. Once the volunteer completes each delegated task that they have excepted, they note their completion of the task. The centralized system then becomes immediately updated with the fact that this task has been completed enabling the staff to monitor the progress of tasks and identify those tasks as being complete. The system may then increase that volunteer's impact points 4018 accordingly. In a further aspect of this embodiment, the staff may provide a subjective grade for the volunteer based on the quality of their work or contribution, not merely on the quantity of their work. This internal grade 4019 is viewable only by the staff and may be used as a weighting factor to determine whether this volunteer is designated for further tasks or is passed over.

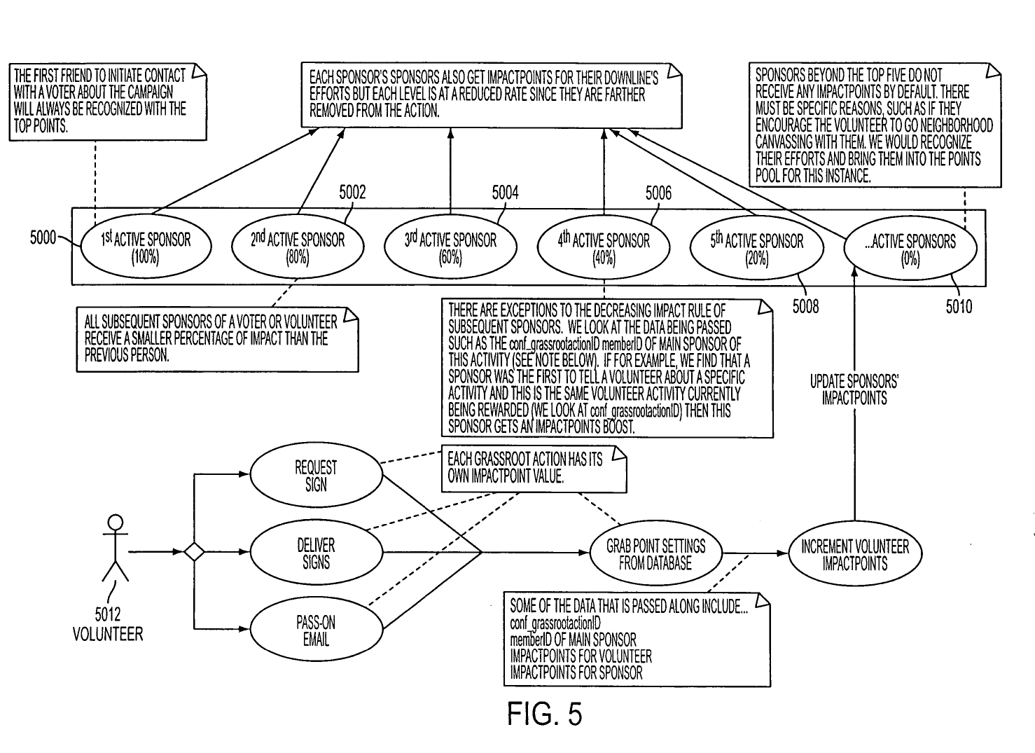

FIG. 5 illustrates the technical operation by which the volunteers are linked to their sponsors in the database for the purposes of proper tracking and awarding of impact points. Specifically, the first volunteer 5000 to initiate contact with a voter about the campaign will always be recognized with the highest multiplier of impact points. However, the system understands that in a volunteer organization and especially in a political campaign, a particular voter may be contacted by more than one volunteer. Thus, the system recognizes the first person to reach out to a voter with the most impact points, but does not ignore the contribution of subsequent volunteers. Thus, the system is able to award every decreasing multipliers of an impact points to a second subsequent volunteers who has taken subsequent volunteers 5012, 5014, 5006, 5008, 5010 will also contact that voter. Thus, there is reduced negative friction between volunteers if one recruits a mutual friend first. In addition, this establishes the upline, downline hierarchy of the volunteers.

While this may at first appear to be similar to multi-level marketing schemes in which uplines receive a share of the revenue of the sales of their downlines. The system at the present invention enables a further dimension of analysis, thus, the upline, downline relationship is maintained but the system also retains information about the order in which downlines were contacted and is able to provide each member of the organization, regardless of their placement or their position in the hierarchy, with a view of all of those people in the organization that they have a direct contact with. This is a flat relationship display, or buddy list as discussed above with respect to the volunteer homepage, rather than a hierarchal pyramid or tiered structure. Thus the system of the present invention allows both a flat relationship manager and tiered structure to co-exist with the same contact information on the same database. In a further environment in the present invention, the number of sponsors who are awarded the impact points may be capped at a certain number to prevent the awarding of de minimus impact points. In the example illustrated in FIG. 5, only the first five sponsors to contact a voter are awarded impact points ranging from 100% to the first sponsor 5000, 80% to the second sponsor 5002, 60% for the third sponsor 5004, 40% for the fourth sponsor 5006, and 20% for the fifth sponsor 5008. Subsequent sponsors of that same voter are not awarded impact points unless that sponsor has encouraged that downline volunteer to conduct a specific activity with them. Thus, the sixth or subsequent sponsor is not automatically award impact points for all of their downlines. Volunteer efforts are awarded impact points in those situations where they and their downline participate in the same activity.

A further exception to the decreasing impact point rule is in those situations where the sponsor was the first to tell a volunteer about a specific activity and if this activity is the activity for which the downline volunteer is being rewarded, this particular sponsor is awarded impact points boost. For example, if the fourth sponsor 5006 is the first to encourage the downline volunteer to participate in a specific neighborhood canvassing effort, then the fourth sponsor may be awarded additional impact points based on the downline's participation in that activity. For example, that fourth active sponsor is awarded more impact points than merely 40% for that downline's efforts in that activity. However, the prior sponsors, the other eligible sponsors may still be awarded their pre-determined impact points. Thus, when a volunteer 5012 requests a sign, delivers a signs, or passes out an e-mail, each one of those activities are grassroots actions that have a pre-determined impact point value assigned to them. Thus, point values are obtained from the database and passed back through the system to the volunteer. In addition, not only are the values of impact points being passed, the system also passes the information about primary sponsor and all other sponsors so that when the volunteer impact points are incremented, the system will recursively navigate up through the hierarchy awarding the impact points to those sponsors in distant levels above this particular volunteer.

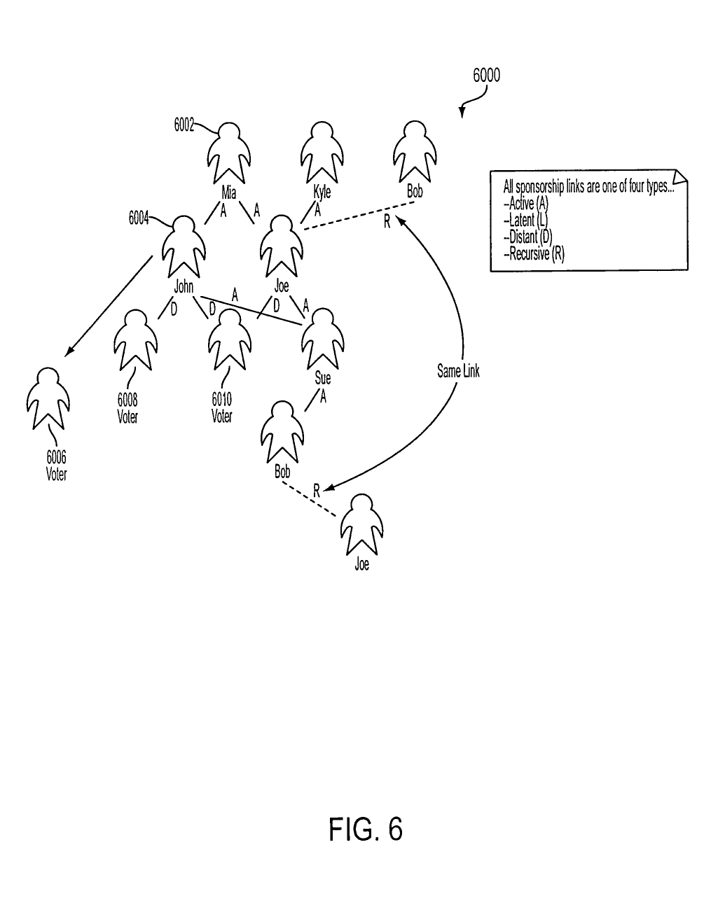

In order to enable this functionality, the system is able to tract four kinds of links between volunteers. A link may bean active link, a latent link, a distant link and a recursive link 6000 as illustrated in FIG. 6. An active link is simply a link between two volunteers adjacent to one another in the sponsorship hierarchy. The volunteer 6002 named Mia has active links with downline volunteers John and Joe who Mia has sponsored. However, Kyle may have been a second sponsor of Joe as well, thus an active link is maintained between Kyle and Joe as well as between Joe and Mia. In other words, because John and Joe were brought into the campaign directly by Mia first, then Kyle, those links are identified as active links in the database and those points will be awarded to Mia and Kyle for actually bringing in Joe, for example. A latent link is established between a volunteer such as John 6004 and a voter 6006. This latent link connection is stored in the database simply to remember which voters were contacted by which volunteers so that if at some point in the future voter 6006 becomes a volunteer, then voter 6006 is elevated to the a distant link with respect to John. Then John would only get a percentage of impact points that the distant voter 6008 receives. In other embodiments, distant links may not be awarded impact points.

The recursive link is needed in order to maintain the integrity of the database. For example, it is very possible that circumstances may arise in which the same person is contacted by two people who are at different levels of the volunteer sponsor hierarchy. For example, in FIG. 6 Joe was contacted by Kyle first, thus giving Kyle an active connection to Joe, but also by Bob who is a downline of Sue's who is in turn Joe's downline. An active link cannot be established between Bob and Joe because Joe is two levels above Bob in the hierarchy already. Thus, the system needs some mechanism to retain information that Bob has made a direct connection to Joe, but also that Bob should not be awarded any of Joe's impact point because Joe was higher than him in the hierarchy, thus a recursive link is established between Bob and Joe. The advantage of such a recursive link lies also in that it enables Bob to see both Sue and Joe when viewing his direct connections (or buddy list) even though in the absence of the recursive link he would not be able to see Joe because Joe is not an active link in the database. Furthermore, the recursive link allows the system to identify Joe as an upline but not award him impact points more than once during the awarding of impact points for Bob.

The mechanism for awarding impact points based on the hierarchy illustrated in FIG. 6 is as follows: if Bob conducts a grassroots activity, Sue obtains impact points for Bob, Joe obtains a percentage of Sue's percentage of Bob's impact points. Mia and Kyle will also be awarded a percentage of that percentage based on their priority in sponsoring Joe. The system begins with Bob, awards him impact points and then navigates the tree based on active links toward impact points. In the example where Joe is awarded impact points, all of the links to Joe are identified, those links being the active links to Mia and Kyle as well as the recursive link to Bob. The recursive link to Bob is not followed for the purpose of awarding impact points, but Mia and Kyle are awarded impact points based on their priority of sponsoring Joe.

However, if Bob informs Joe of a specific activity and participates with Joe on that activity, Bob may be additionally or alternatively awarded impact points for encouraging Joe to participate in the specific activity in which Bob himself also participated. Likewise, if Sue is awarded impact points for her participation in the activity, Joe is awarded impact points as her active link direct upline. John is awarded impact points as her direct upline also based on their priority.

A voter 6010 maintaining distant link to both John and Joe is awarded impact points once they become a volunteer and participate in an activity. John and Joe are awarded a reduced number of impact points because voter 6010 has become a volunteer subsequent to John's and Joe's initial contact, therefore, each of them receive a percentage. Mia and Kyle being John's and Joe's uplines respectively, receive a percentage of the percentage that John and Joe received in impact points.

The system further distinguishes from a multilevel marketing structure in that the compensation being awarded is not monetary, thus the number of impact points may begenerated or created in an unlimited manner. Related art multilevel marketing structures where a percentage of the dollar revenue earned by the downlines, implies that there is a fixed and limited pool of money from which upline revenue may bedrawn. In the impact point context there is no such upper limit—rather, impact points may be created anew and awarded throughout the course of the campaign.

By awarding impact points in a tiered structure, the campaign is able to identify those volunteers who have brought in their own successful group of volunteers. This may be valuable information for a campaign trying to identify those people that are able to motivate supporters to become volunteers. Furthermore, the campaign is able to run monthly, weekly or periodical reports of who has the most impact points or the most impact points based on specific kind of activity and may make personalized efforts to congratulate or thank that volunteer. For example, the candidate himself may take time out of his schedule to call and congratulate a volunteer who has received the highest number of impact points that week. This kind of personal recognition serves to only further motivate that volunteer into performing even more activity and recruiting even more volunteers for the campaign. Thus, the system of the present invention as described with respect to the embodiment discussed herein enables volunteers to receive recognition for their efforts, to efficiently delegate tasks to those volunteers with a reward system that encourages volunteers to accept those tasks and perform them in a timely and efficient manner. Thus, the system provides advantages over traditional labor force management systems because it is able provide a motivational structure that does not generate structural competition within the organization, yet effectively and efficiently motivates volunteers to accomplish what the organization needs to have done.

It will be apparent to those skilled in the art that various modifications and variation may be made in the present invention without departing from the spirit or scope of the invention. Thus, it is intended that the present invention cover the modifications and variations of this invention provided they come within the scope of the appended claims and their equivalents.

What is claimed is:

1. A system for managing a political campaign, comprising:
a database server;
a database;
data of contacts, said contacts being anyone associated with the political campaign, said data comprising at least a contact ID;
said data of contacts including at least one of contact information and demographic information about at least one contact;
data identifying each contact in the database as a voter, supporter, volunteer, or staff member;
data identifying a plurality of activity categories associated with the campaign;
data of specific activities requiring volunteer participation, each of said activities belonging to at least one of said activity categories;
data of volunteers assigned to participate in at least one of said activities; and
data about a designated number of merit based recognition points awarded for each of said activities,
wherein data identifying a contact as a volunteer comprises data identifying at least one sponsor of said volunteer using contact ID and data of priority, said data of priority determining the order in which sponsors contacted the volunteer.
